(19) United States
(12) Patent Application Publication
(10) Pub. No.: US 2026/0064798 A1
(43) Pub. Date: Mar. 5, 2026

(54) OPTIMIZING APPARATUS, OPTIMIZING METHOD, AND OPTIMIZING PROGRAM

(71) Applicant: NTT, Inc., Tokyo (JP)

(72) Inventors: Yuya HIKIMA, Musashino-shi (JP); Yasunori AKAGI, Musashino-shi (JP); Hideaki KIN, Musashino-shi (JP); Taichi ASAMI, Musashino-shi (JP); Hiroyuki TODA, Musashino-shi (JP)

(73) Assignee: NTT, Inc., Tokyo (JP)

(21) Appl. No.: 19/105,823

(22) PCT Filed: Aug. 26, 2022
(86) PCT No.: PCT/JP2022/032253

§ 371 Date: Feb. 24, 2025

(51) Int. Cl. G06F 17/11

(52) U.S. Cl. CPC G06F 17/11

(57) ABSTRACT

A optimizing apparatus capable of solving an online matching problem according to an embodiment includes: circuitry configured to acquire input data including information regarding the node, a remaining amount given to a fixed node among nodes, the appearance probability given to an appearance node among the nodes, and a reward given to each edge when matching is performed, perform formulation to a first optimization problem based on the input data, determine whether or not all of the appearance nodes satisfy a predetermined assumption, perform transformation into a second optimization problem capable of obtaining an approximate solution that is a variable that controls a weight of each node and the appearance probability in the first optimization problem and a matching strategy in a case where the predetermined assumption is satisfied, obtain the approximate solution by solving the second optimization problem, and output the approximate solution.

### TECHNICAL FIELD

The present invention relates to an optimizing apparatus, an optimizing method, and an optimizing program.

### BACKGROUND ART

Online matching is known as an optimization problem applicable in various applications. This is a special matching problem regarding a certain bipartite graph G=(U, V, E). This problem is to allocate uϵU to v ϵV that appears at each time t when a fixed node set U existing in advance and an appearance node set V that may appear in the future are given. Here, it is assumed that each fixed node u has a remaining amount rᵤ and allocation more than the remaining amount rᵤ is not possible.

For example, online matching may be applied to allocation of Internet advertisements (U). A given advertisement frame is allocated to a website viewer (V) about which it is not known in advance in which website the website viewer appears.

Furthermore, the online matching can also be applied to crowdsourcing for allocating a task (U) to be solved to a worker (V) that appears sequentially via the Internet, a taxi platform for allocating a vacant taxi (U) to an orderer (V) that appears sequentially, or the like.

At this time, since the reward at the time of allocating the task to the worker is “monetary value due to the task being performed—salary”, the reward depends on the salary x_{VE}. In addition, since each worker determines whether or not to participate in the market at the time according to the salary x_{VE}, the appearance probability of each worker at the time t is also affected.

For example, Non Patent Literature 1 discloses a technique for determining such a variable xᵥₜ and a matching strategy in online matching having a controllable reward and an arrival rate.

### CITATION LIST

### Non Patent Literature

Non Patent Literature 1: Yuya Hikima, Yasunori Akagi, Naoki Marumo, and Hideaki Kim. Online matching with controllable rewards and arrival probabilities. In International Joint Conference on Artificial Intelligence, 2022. Internet <URL: https://www.ijcai.org/proceedings/2022/0254.pdf>
Non Patent Literature 2: Alaei, Saeed, MohammadTaghi Hajiaghayi, and Vahid Liaghat. “Online prophet inequality matching with applications to ad allocation.” Proceedings of the 13th ACM Conference on Electronic Commerce. 2012. Non Patent Literature 3: Ahuja, R. K.; Magnanti, T. L.; and Orlin, J. B. 1993. Network Flows: Theory, Algorithms, and Applications. Prentice-Hall

### SUMMARY OF INVENTION

### Technical Problem

For example, in Non Patent Literature 1, there is a problem that the approximation rate, which is a theoretical guarantee of the quality of a solution to be output, is as low as ½, and a favorable solution may not be output. Furthermore, there is a problem that, in a case where the remaining amount rᵤ of each node u takes a large value, calculation takes a long time.

The present invention has been made in view of the above circumstances, and an object thereof is to provide an approximate solution method that ensures a better approximation rate than before for an optimization problem that simultaneously determines a matching strategy, a weight of a node, and a variable x_{VE} that controls an appearance probability. Furthermore, an object thereof is to provide a technique in which the calculation time is not increased even in a case where the remaining amount rᵤ of each node u takes a large value.

### Solution to Problem

In order to solve the above problem, according to an aspect of the present invention, there is provided an optimizing apparatus capable of solving an online matching problem capable of controlling each node and an appearance probability. The optimizing apparatus includes an acquisition unit that acquires input data including information regarding the node, a remaining amount given to a fixed node among nodes, the appearance probability given to an appearance node among the nodes, and a reward given to each edge when matching is performed, a formulation unit that formulates a first optimization problem that maximizes a total of rewards obtained based on the input data, a determination unit that determines whether or not all of the appearance nodes satisfy a predetermined assumption, a transformation unit that performs transformation into a second optimization problem capable of obtaining an approximate solution to a variable that controls a weight of each node and the appearance probability in the first optimization problem and a matching strategy in a case where the predetermined assumption is satisfied, a problem solving unit that obtains the approximate solution by solving the second optimization problem, and an output control unit that outputs the approximate solution.

### Advantageous Effects of Invention

According to an aspect of the present invention, it is possible to provide an approximation solution method that ensures a better approximation rate than before for an optimization problem, and further to provide a technique in which the calculation time is not increased even in a case where the remaining amount rᵤ of each node u takes a large value.

### BRIEF DESCRIPTION OF DRAWINGS

FIG. 1 is a block diagram illustrating an example of a hardware configuration of an optimizing apparatus according to an embodiment.

FIG. 2 is a block diagram illustrating a software configuration of the optimizing apparatus according to the embodiment in association with the hardware configuration illustrated in FIG. 1.

FIG. 3 is a diagram illustrating an example of a problem addressed in the present invention.

FIG. 4 is a diagram illustrating an example of a minimum convex cost flow problem.

FIG. 5 is a flowchart illustrating an example of an operation for the optimizing apparatus to calculate an approximate solution or an optimal solution to an optimization problem in online matching.

FIG. 6 is a flowchart for explaining step ST103 in detail.

### DESCRIPTION OF EMBODIMENTS

Hereinafter, an embodiment according to the present invention will be described with reference to the drawings. Note that, hereinafter, the same or similar reference signs will be given to components that are the same as or similar to those already described, and redundant description will be basically omitted. For example, in a case where there are a plurality of the same or similar components, a common reference sign may be used to describe each component without distinguishing the components, or a branch number may be used in addition to the common reference sign to describe each component distinctly.

### Embodiment

### (Configuration)

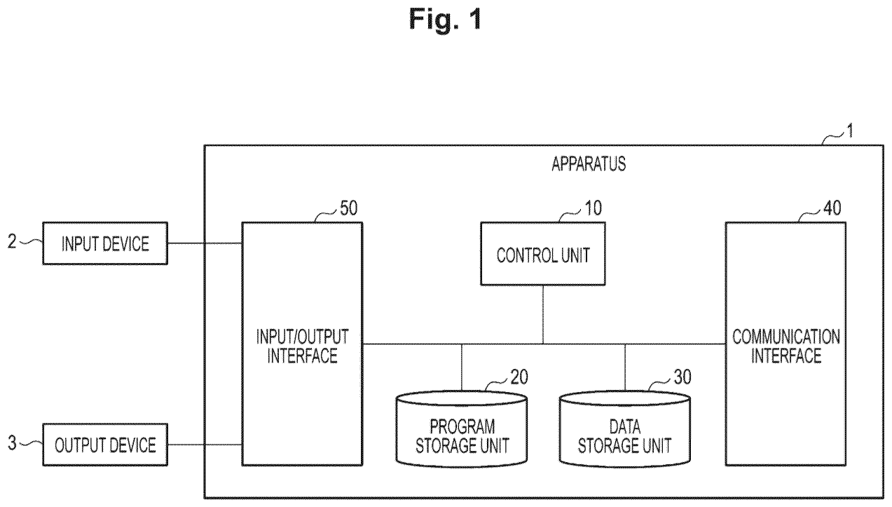

FIG. 1 is a block diagram illustrating an example of a hardware configuration of an optimizing apparatus 1 according to an embodiment.

The optimizing apparatus 1 is a computer that analyzes input data and generates and outputs output data. For example, the optimizing apparatus 1 is installed in a certain place set by an administrator who manages the optimizing apparatus 1.

As illustrated in FIG. 1, the optimizing apparatus 1 includes a control unit 10, a program storage unit 20, a data storage unit 30, a communication interface 40, and an input/output interface 50. The control unit 10, the program storage unit 20, the data storage unit 30, the communication interface 40, and the input/output interface 50 are communicably connected to each other via a bus. Further, the communication interface 40 may be communicably connected to an external device via a network. Furthermore, the input/output interface 50 is communicably connected to an input device 2 and an output device 3.

The control unit 10 controls the optimizing apparatus 1. The control unit 10 includes a hardware processor such as a central processing unit (CPU). For example, the control unit 10 may be an integrated circuit capable of executing various programs.

The program storage unit 20 can be used using, as a storage medium, a combination of a nonvolatile memory on which writing and reading can be performed as needed, such as an erasable programmable read only memory (EPROM), a hard disk drive (HDD), or a solid state drive (SSD), and a nonvolatile memory such as a read only memory (ROM), for example. The program storage unit 20 stores programs necessary for executing various types of processing. That is, the control unit 10 can implement various controls and operations by reading and executing the program stored in the program storage unit 20.

The data storage unit 30 is a storage using, as a storage medium, a combination of a nonvolatile memory on which writing and reading can be performed as needed, such as an HDD or a memory card, and a volatile memory such as a random access memory (RAM), for example. The data storage unit 30 is used to store data acquired and generated in a process in which the control unit 10 executes a program to perform various types of processing.

The communication interface 40 includes one or more wired or wireless communication modules. For example, the communication interface 40 includes a communication module that establishes wired or wireless connection with an external device via a network. The communication interface may include a wireless communication module wirelessly connected to an external device such as a Wi-Fi access point and a base station. Further, the communication interface 40 may include a wireless communication module that performs wireless connection with an external device using a short-distance wireless technique. That is, the communication interface 40 may be a general communication interface as long as it can communicate with an external device and transmit and receive various types of information under the control of the control unit 10.

The input/output interface 50 is connected to the input device 2, the output device 3, and the like. The input/output interface 50 is an interface that enables transmission and reception of information between the input device 2 and the output device 3. The input/output interface 50 may be integrated with the communication interface 40. For example, the optimizing apparatus 1 and at least one of the input device 2 and the output device 3 are wirelessly connected using a short-range wireless technique or the like, and may transmit and receive information using the short-range wireless technique.

The input device 2 may include, for example, a keyboard, a pointing device, and the like for a user to input various types of information to the optimizing apparatus 1. In addition, the input device 2 may include a reader for reading data to be stored in the program storage unit 20 or the data storage unit 30 from a memory medium such as a USB memory, and a disk device for reading such data from a disk medium.

The output device 3 includes a display or the like that displays a result or the like calculated by the control unit 10. In addition, the output device 3 includes a printer or the like that prints information displayed on the display.

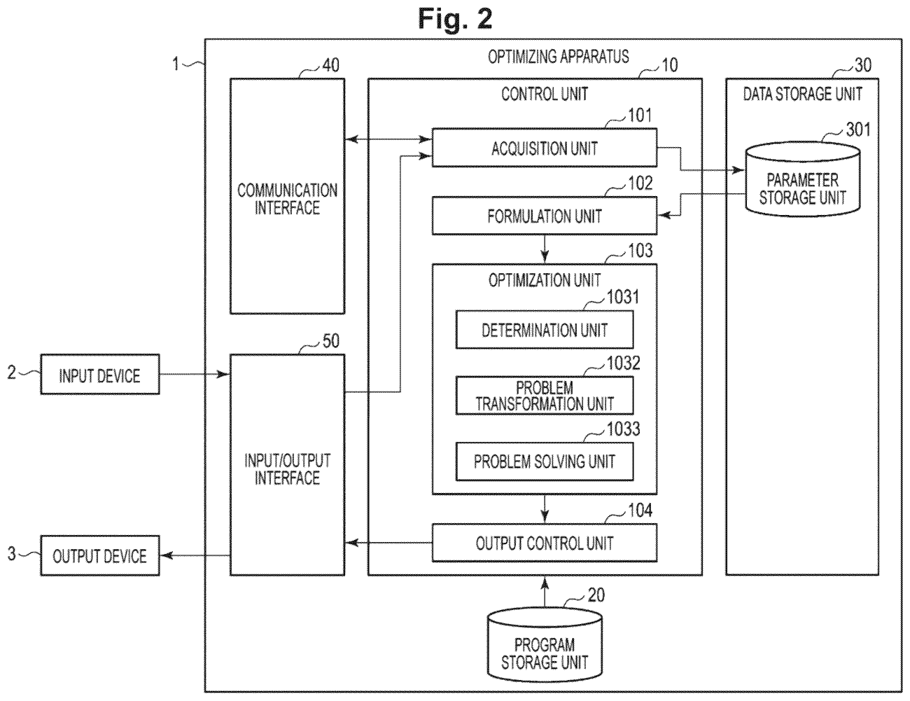

FIG. 2 is a block diagram illustrating a software configuration of the optimizing apparatus 1 in the embodiment in association with the hardware configuration illustrated in FIG. 1.

The control unit 10 includes an acquisition unit 101, a formulation unit 102, an optimization unit 103, and an output control unit 104.

The acquisition unit 101 acquires input data. When input data is input to the input device 2, the input device 2 stores the input data in a parameter storage unit 301. Note that details of the input data will be described later.

The formulation unit 102 formulates an optimization problem. The formulation unit 102 acquires the input data stored in the parameter storage unit 301. Then, based on the input data, the formulation unit 102 determines a matching strategy that designates which fixed node is allocated to an appearance node, and formulates an optimization problem (P) that maximizes the total of the obtained rewards. Note that details of the optimization problem (P) will be described later.

The optimization unit 103 calculates an optimal solution or an approximate solution to the formulated problem. The optimization unit 103 further includes a determination unit 1031, a problem transformation unit 1032, and a problem solving unit 1033.

The determination unit 1031 determines whether or not all appearance nodes satisfy a predetermined assumption. Note that the predetermined condition will be described later. In a case where the predetermined assumption is satisfied, the determination unit 1031 outputs the optimization problem (P) to the problem transformation unit 1032. On the other hand, in a case where the predetermined assumption is not satisfied, the optimization problem (P) is output to the problem solving unit 1033.

The problem transformation unit 1032 transforms the optimization problem (P) into a minimum convex cost flow problem (FP). Note that a detailed method of transforming the optimization problem (P) into the minimum convex cost flow problem will be described later. The problem transformation unit outputs the transformed minimum convex cost flow problem to the problem solving unit 1033.

Upon receiving the minimum convex cost flow problem (FP), the problem solving unit 1033 solves the minimum convex cost flow problem (FP) by using a known solution method for the minimum convex cost flow problem (FP), and calculates an optimal solution to the minimum convex cost flow problem. Note that this optimal solution corresponds to an approximation rate of the optimization problem. On the other hand, upon receiving the optimization problem (P), the problem solving unit 1033 solves the optimization problem (P) by using a general method (for example, a heuristic solution method, an approximate solution method, or the like).

The output control unit 104 outputs the variable and the matching strategy to the output device 3. For example, the output control unit 104 performs control to display the variable and the matching strategy on the display of the output device 3.

The data storage unit 30 includes the parameter storage unit 301. The parameter storage unit 301 is used to store the input data acquired by the acquisition unit 101.

### (Operation)

First, the problems addressed in the present invention will be described.

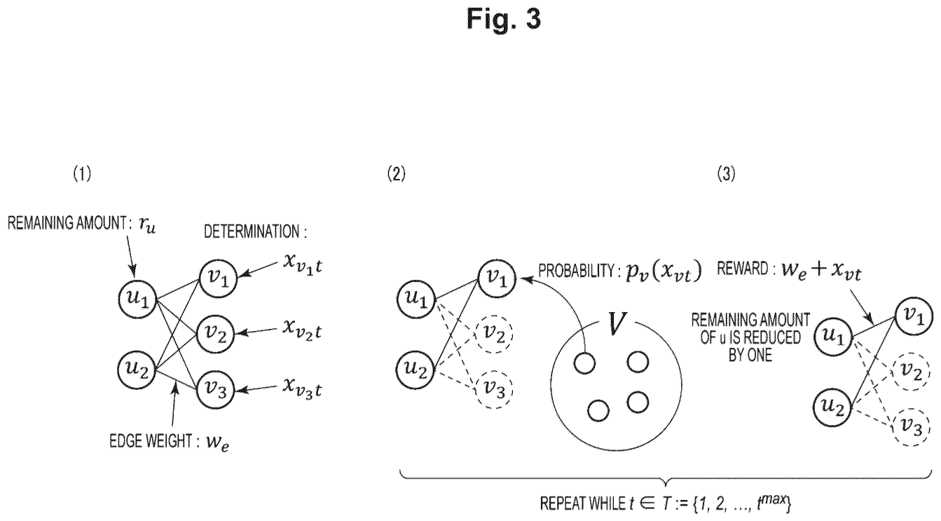

FIG. 3 is a diagram illustrating an example of a problem addressed in the present invention.

In the example of FIG. 3, a special online matching problem related to the bipartite graph G=(U, V, E) is represented. First, t ϵT: =(1, 2, . . . , t^{max}} is given as a time step at which a participant (appearance node) v appears. In addition, a constant (edge weight) wₑ is given to each edge eϵE in advance, and a function (appearance probability) pᵥ is given to each appearance node v ϵV in advance. Further, a remaining amount re is given to each fixed node u in advance.
(1) of FIG. 3 illustrates an initial state. In (1), a variable xᵥₜ is determined for each appearance node v ϵV and time tϵT.
(2) and (3) of FIG. 3 illustrate a situation repeated during each time step. In (2), the appearance node v appears with a probability of the appearance probability pᵥ(xᵥₜ). Alternatively, it is assumed that the participant v does not appear with a probability of 1-Σᵥpᵥ(xᵥₜ). In (3), in a case where a certain appearance node v appears, the reward wₑ+xᵥₜ is obtained by allocating a node u having a remaining amount to the appearance node v, and then the remaining amount rᵤ of the node u is reduced by one. Alternatively, nothing is allocated to the node. (2) and (3) are repeated while the time t is tϵT.

Then, a problem to be solved in the present embodiment is a problem of determining the variable x_{VE} (v ϵV, t ϵT) in (1) of FIG. 3 and a matching strategy that designates which node u is allocated to the appearance node v appearing in (3), and maximizing the total value of the obtained rewards.

At this time, this problem can be formulated as the following optimization problem (P).

$$[ Math . 1 ]$$

$$( P ) {max}_{x ∈ {ℝ}^{V \times T} , π ∈ Π} {𝔼}_{ξ - D ( x )} [ f ( π , x , ξ ) ]$$

Here, ξ ϵ{v₁, v₂, . . . , vₙ, ⊥}^{T} is a random variable, ξₜ=vₖ represents that an appearance node (participant) vₖ appears at the time t, and ξₜ=⊥ represents that no appearance node has appeared at the time t. D(x) is a probability distribution of ξϵ{v₁, v₂, . . . , vₙ, ⊥}^{tmax}, and a probability mass function thereof is Pr(ξ|x)=Π_{tϵτ}Pr(ξₜ|x). However, for each v ϵ{v₁, v₂, . . . , vₙ}, Pr(ξₜ=v|x)=pᵥ(xᵥₜ), and Pr(ξₜ=⊥|x)=1−Σ_{vϵ}vpᵥ(xᵥₜ). The variable a represents the matching strategy in (3) of FIG. 1, and Π is a set of all strategies. The function f(n, x, ξ) is the sum of matching rewards obtained when (n, x, ξ) is given.

By solving the optimization problem (P), the optimum reward x and the matching strategy n can be determined. Any optimizing method may be used as long as an optimal solution or an approximate solution of the optimization problem (P) can be derived. For example, the method disclosed in Non Patent Literature 1 can be applied as a solution method to the optimization problem (P). However, as described above, the approximation rate is poor, and the calculation time greatly increases as the remaining amount rᵤ increases.

Therefore, it is assumed that the approximate solution method described below can be applied when Assumption 1 as follows is satisfied.

Assumption 1: for all appearance nodes v ϵV, the appearance probability pᵥ(x) is limₓ₋−pᵥ(x)=0. Alternatively, the variable x in which the appearance probability pᵥ(x)=0 is included in the domain. In addition, −p′ᵥ(x)/pᵥ(x) is monotonically non-decreasing with respect to x, and the appearance probability pᵥ(x) is bijective and monotonically decreasing. Here, p′v(x) represents a derivative of pᵥ(x).

This assumption is satisfied, for example, when a complementary cumulative distribution function of a normal distribution and a Gumbel distribution is used as the appearance probability pᵥ. These distributions are distributions commonly used in the field of machine learning, and the above assumption is an assumption that satisfies many distributions used in actual application.

Next, the approximation of the function max_{nϵΠ}E_{ξ-D(x)} [f(n, x, ξ)] is considered.

A function that approximates the function max_{nϵΠ}E_{ξ-D(x)} [f(n, x, ξ)] is considered. It is assumed that the matching strategy disclosed in Non Patent Literature 2 with respect to any x is n^{H}(x). In addition, it is assumed that the optimal value of the following linear programming problem is f\hat{ }(x).

$$[ Math . 2 ]$$

$${max}_{z ∈ {[ 0 , 1 ]}^{E \times T}} {\sum }_{t ∈ T} {\sum }_{e = ( u , v ) ∈ E} ( {x}_{v} + {w}_{e} ) {z}_{et} \\ s . t . {\sum }_{e ∈ δ} {z}_{et} \leq {p}_{v} ( {x}_{vt} ) , ∀ v ∈ V , ∀ t ∈ T , \\ {\sum }_{t ∈ T} {\sum }_{e ∈ δ ( u )} {z}_{et} \leq {r}_{u} , ∀ u ∈ U , ∀ t ∈ T ,$$

Here, δ(α) represents a set of sides connected to the node α.

At this time, an inequation as follows is established (see, for example, Non Patent Literature 2).

$$[ Math . 3 ]$$

$$\begin{matrix}\frac{1}{1 - \sqrt{3 + k}} \hat{f} ( x ) \leq {𝔼}_{ξ - D ( x )} [ f ( {π}^{H} ( x ) , x , ξ ) ] \\ \leq {max}_{π ∈ Π} {𝔼}_{ξ - D ( x )} [ f ( π , x , ξ ) ] \\ \leq \hat{f} ( x )\end{matrix}$$

Assuming that the following expression is obtained from the above expression, (x*, n*) is an approximate solution that can achieve the 1/(1−√(3+k)) approximation rate of the optimization problem (P).

$$[ Math . 4 ]$$

$${x}^{*} := arg {max}_{x ∈ {ℝ}^{V \times T}} \hat{f} ( x ) , {π}^{*} := {π}^{H} ( {x}^{*} )$$

Here, k=minᵤrᵤ.

It is considered that, from the above description, the optimization problem (PA) as follows is solved.

$$[ Math . 5 ]$$

$${max}_{x ∈ {ℝ}^{V \times T}} \hat{f} ( x )$$

This optimization problem (PA) can be expressed as follows.

$$[ Math . 6 ]$$

$$( PA ) \\ {max}_{{x ∈ {ℝ}^{V \times T} ,}_{z ∈ {[ 0 , 1 ]}^{E \times T}}} {\sum }_{t ∈ T} {\sum }_{e = ( u , v ) ∈ E} ( {x}_{vt} + {w}_{e} ) {z}_{et} \\ s . t . {\sum }_{e ∈ δ ( v )} {z}_{et} \leq {p}_{v} ( {x}_{vt} ) , ∀ v ∈ V , ∀ t ∈ T , \\ {\sum }_{t ∈ T} {\sum }_{e ∈ δ ( u )} {z}_{et} \leq {r}_{u} , ∀ u ∈ U , ∀ t ∈ T ,$$

By solving the optimization problem (PA), an approximate solution that achieves the 1/(1−√(3+k)) approximation rate to the optimization problem (P) can be obtained. Therefore, in the present embodiment, it is assumed that the optimization problem (PA) is solved at a high speed and the approximate solution is obtained.

When Assumption 1 described above is satisfied, regarding pᵥxᵥₜ≥Σₑ_{^{ϵδ(v)}} zₑₜ, which is the first constraint of the optimization problem (PA), an equation is necessarily satisfied in a certain optimal solution (x*, x*). That is, pᵥxᵥₜ=Σₑ_{^{ϵδ(v)}} zₑₜ. Therefore, in the optimization problem (PA), the following optimization problem (CP) with xᵥₜ:=pᵥ⁻¹ (Σₑ_{^{ϵδ(v)}} zₑₜ) can be considered.

$$[ Math . 7 ]$$

$$( CP ) \\ {max}_{x ∈ {[ 0 , 1 ]}^{E \times T}} {\sum }_{t ∈ T} ( {\sum }_{e ∈ V} {p}_{v}^{- 1} ( {\sum }_{e ∈ δ ( v )} {z}_{et} ) {\sum }_{e ∈ δ ( v )} {z}_{et} + {\sum }_{e ∈ E} {w}_{e} {z}_{et} ) \\ s . t . {\sum }_{e ∈ δ ( v )} {z}_{et} \leq {S}_{v} , {∀}_{v} ∈ V , ∀ t ∈ T , \\ {\sum }_{t ∈ T} {\sum }_{e ∈ δ ( u )} {z}_{et} \leq {r}_{u} , {∀}_{v} ∈ U , ∀ t ∈ T ,$$

Here, Sv is a domain of the function pᵥ⁻¹.

When xᵥₜ*:=pᵥ⁻² (Σₑ_{^{ϵδ(v)}} zₑₜ*) is set for the optimum value z* of the above problem, (x*, z*) is the optimal solution to the optimization problem (PA). In addition, it can be shown that an objective function of the optimization problem (CP) is a convex function by Assumption 1. Therefore, this problem can also be solved by using various interior point methods or the like for the convex optimization problem. However, in the present embodiment, as will be described below, a method capable of solving this problem at a high speed by returning to the minimum convex cost flow problem will be described.

Next, a solution method to the optimization problem (CP) through the minimum convex cost flow problem will be described.

When a solution of the following problem is set to z*, z\hat{ } with z\hat{ }ₑ₁= . . . =z\hat{ }ₑₜ^{max}=zₑ*for each of t ϵT and eϵE is an optimal solution to the optimization problem (CP). This is because the optimization problem (CP) has the same structure at each time tϵT. Therefore, solving the following optimization problem (CP′) is considered.

$$[ Math . 8 ]$$

$$( {CP}^{′} ) \qquad ( 1 )$$

$${max}_{z ∈ {[ 0 , 1 ]}^{E}} {\sum }_{v ∈ V} {p}_{v}^{- 1} ( {\sum }_{e ∈ δ ( v )} {z}_{e} ) {\sum }_{e ∈ δ ( v )} {z}_{e} + {\sum }_{e ∈ E} {w}_{e} {z}_{e} \qquad ( 2 )$$

$$s . t . {\sum }_{e ∈ δ ( v )} {z}_{e} ∈ {S}_{v} , ∀ v ∈ V \qquad ( 3 )$$

$${\sum }_{e ∈ δ ( u )} {z}_{e} \leq {r}_{u} / {t}^{max} , ∀ u ∈ U . \qquad ( 4 )$$

At this time, new subscripts s and f are prepared. zₛᵤ:=Σₑ_{^{ϵδ(u)}} zₑ is set for all fixed nodes u, and z_{vf}:=Σₑ_{^{ϵδ(v)}} zₑ is set for all appearance nodes v. In addition, z_{sf} is prepared as a slack variable. At this time, the optimization problem (CP′) can then be rewritten as a minimum convex cost flow problem (FP) as follows.

$$[ Math . 9 ]$$

$$( FP ) \\ {max}_{z ∈ {[ 0 , 1 ]}^{E}} {\sum }_{v ∈ V} - {p}_{v}^{- 1} ( {z}_{vf} ) {z}_{vf} + {\sum }_{e ∈ E} - {w}_{e} {z}_{e} \\ s . t . {\sum }_{u} {z}_{su} + {z}_{sf} = n , {\sum }_{v} {z}_{vt} + {z}_{sf} = n \\ {z}_{su} - {\sum }_{e ∈ δ ( u )} {z}_{e} = 0 ( u ∈ U ) \\ {\sum }_{e ∈ δ ( v )} {z}_{e} - {z}_{vf} = 0 ( v ∈ V ) \\ 0 \leq {z}_{su} \leq {r}_{u} / {t}^{max} ( u ∈ U ) \\ {z}_{vf} ∈ {S}_{v} ( v ∈ v ) \\ 0 \leq {z}_{e} \leq 1 ( e ∈ E ) \\ 0 \leq {z}_{sf} \leq n$$

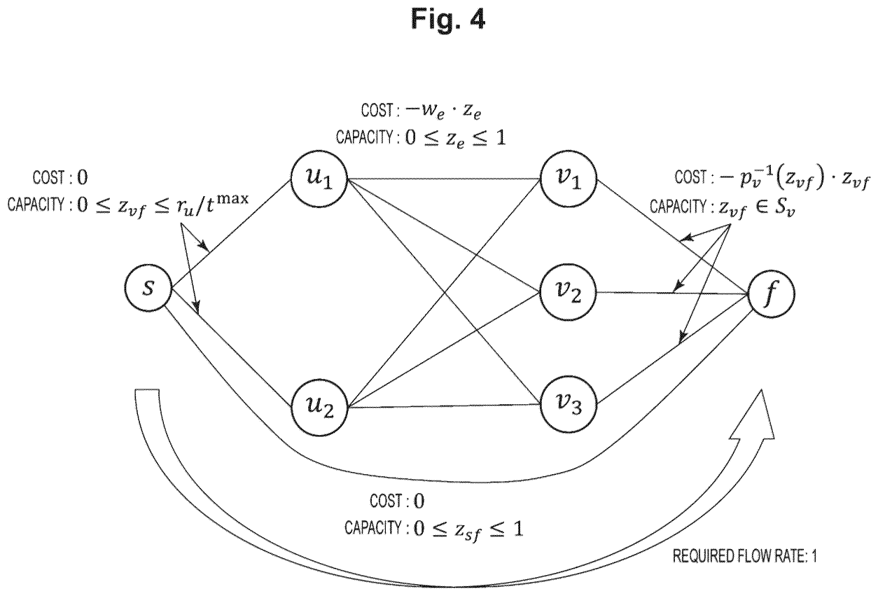

FIG. 4 is a diagram illustrating an example of the minimum convex cost flow problem (FP).

Here, FIG. 4 illustrates a case where U={u1, u2} and V={v₁, v₂, v₃}. As illustrated in FIG. 4, the above-described minimum convex cost flow problem (FP) is to flow a flow (flow rate) from the node s to the node f while satisfying the capacity of each edge, and is to find a flow path that minimizes the total value of the cost for each flow rate.

Therefore, the minimum convex cost flow problem (FP) can be efficiently solved by using the Capacity scaling method (see, for example, Non Patent Literature 3 and the like) or the like, which is a known solution method to the minimum convex cost flow problem (FP). By solving the minimum convex cost flow problem (FP) using this solution method, an optimal solution to the minimum convex cost flow problem can be obtained.

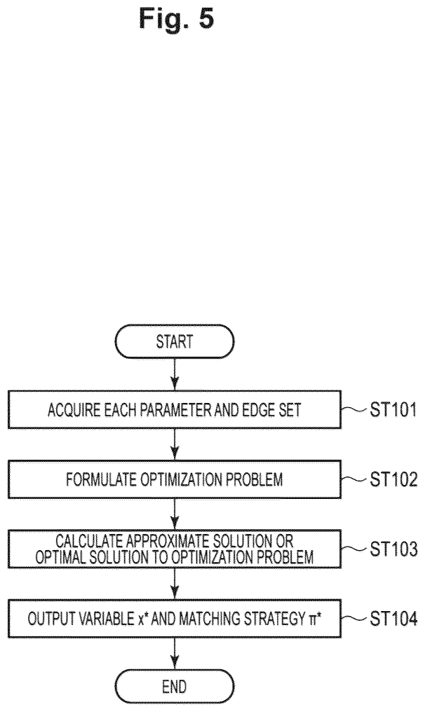

FIG. 5 is a flowchart illustrating an example of an operation for the optimizing apparatus 1 to calculate the approximate solution or the optimal solution to the optimization problem in online matching.

The control unit 10 in the optimizing apparatus 1 reads and executes a program stored in the program storage unit 20, whereby, the operation of the flowchart is implemented.

This flowchart is started when the administrator (user) of the optimizing apparatus 1 inputs input data including various parameters and the like to the input device 2. Note that step ST101 which will be described later is executed when input data from the user is input, but the optimizing apparatus 1 may not immediately execute steps ST102 to ST104. For example, the optimizing apparatus 1 may execute these steps when further receiving an instruction from the user at a predetermined time.

In step ST101, the acquisition unit 101 acquires input data. When input data is input to the input device 2, the input device 2 stores the input data in a parameter storage unit 301. Here, the input data includes a fixed node set U={1, 2, . . . , u^{max}), node information including an appearance node set V=(1, 2, . . . , v^{max}}, an edge set E, a remaining amount rᵤ∀uϵU given to the fixed node u, an edge weight (reward given to each edge when matching is performed) wₑ∀e ϵ E, an appearance probability pᵥ of each appearance node v ϵV, and the like. The acquisition unit 101 outputs the acquired input data to the formulation unit 102.

In step ST102, the formulation unit 102 formulates an optimization problem (P). The formulation unit 102 acquires the input data stored in the parameter storage unit 301. Then, the formulation unit 102 formulates the optimization problem (P) that maximizes the total of the obtained rewards, based on the input data. The formulation unit 102 outputs the formulated optimization problem (P) to the optimization unit 103.

In step ST103, the optimization unit 103 calculates an approximate solution or an optimal solution to the formulated optimization problem (P).

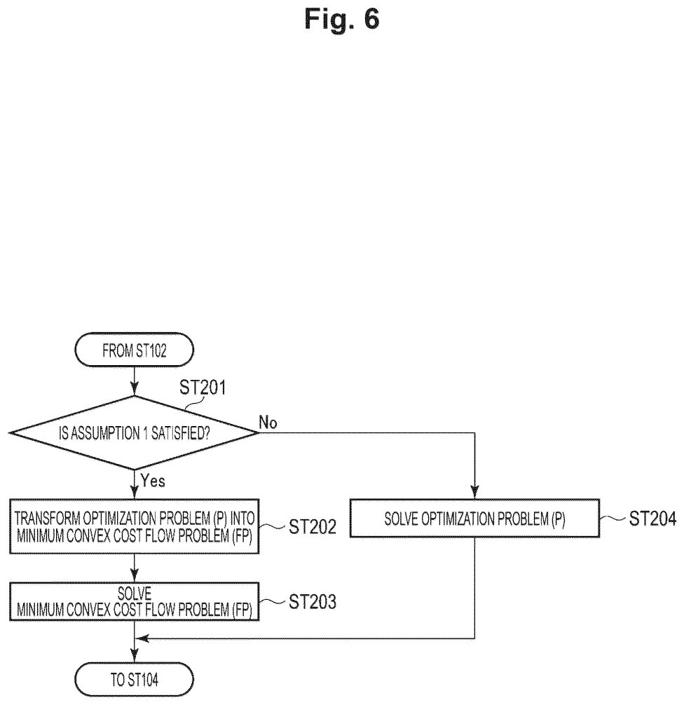

FIG. 6 is a flowchart for explaining step ST103 in detail.

In step ST201, the determination unit 1031 determines whether or not all of the appearance nodes v ϵV satisfy Assumption 1 that is a predetermined assumption. In a case where it is determined that Assumption 1 is satisfied, the process proceeds to step ST202. On the other hand, in a case where it is determined that Assumption 1 is not satisfied, the process proceeds to step ST204.

In step ST202, the problem transformation unit 1032 transforms the optimization problem (P) into the minimum convex cost flow problem (FP) described above. Specifically, the problem transformation unit 1032 transforms the optimization problem into an optimization problem (PA) that can obtain an approximation rate of the optimization problem. At this time, an approximate solution with an approximation rate of(1-√(k+3)) can be obtained by solving (PA). Furthermore, the problem transformation unit 1032 transforms the optimization problem (PA) into an optimization problem (CP) in which an objective function becomes a convex function according to Assumption 1. Then, the problem transformation unit 1032 performs transformation into a minimum convex cost flow problem (FP) based on a point that the optimization problem (CP) has the same structure at each time. Then, the problem transformation unit 1032 outputs the minimum convex cost flow problem (FP) to the problem solving unit 1033. In addition, the problem transformation unit 1032 may output the optimization problem (PA) and the optimization problem (CP) to the problem solving unit 1033.

In step ST203, the problem solving unit 1033 solves the minimum convex cost flow problem (FP) by using a known solution method (for example, the Capacity scaling method) for the minimum convex cost flow problem (FP), and calculates an optimal solution to the minimum convex cost flow problem. A variable and a matching strategy (x*, n*) that are the calculated optimal solutions, that is, control the weight and the appearance probability of each node of the optimization problem (P) are calculated. Here, it is a matter of course that the problem solving unit 1033 may solve the optimization problem (PA) or the optimization problem (CP). The problem solving unit 1033 outputs the calculated variable and matching strategy (x*, n*) to the output control unit 104. That is, the process proceeds to step ST104.

In step ST204, the problem solving unit 1033 solves the optimization problem (P). On the other hand, in a case where Assumption 1 is not satisfied in step ST201, it is not possible to transform the optimization problem (P) into the minimum convex cost flow problem (FP). In this case, the determination unit 1031 outputs the formulated optimization problem (P) to the problem solving unit 1033. Then, the problem solving unit 1033 solves the optimization problem (P) by using a general method (for example, a heuristic solution method, an approximate solution method, or the like). Then, the problem solving unit 1033 outputs the solution obtained by solving to the output control unit 104. That is, the process proceeds to step ST104.

In step ST104, the output control unit 104 outputs the variable x* and the matching strategy n* to the output device 3. For example, the output control unit 104 performs control to display the variable x* and the matching strategy n* on the display of the output device 3.

For example, in an application such as crowdsourcing, k of the approximation rate 1/(1-√(3+k)) is large in many cases. In this case, a high approximation rate can be achieved. For example, in an annotation task or the like, the amount of each task is equal to or more than 100 in many cases. Therefore, k≥100. At this time, the approximation rate is 1-1/(√(3+k))>1−1/√103>0.9, which is much better than the conventional approximation rate of ½. In addition, the above-described solution method has an advantage that the calculation time does not greatly increase even in a case where the remaining amount rᵤ of each node u takes a large value.

### Effects and Advantages of Embodiment

According to the present embodiment, the optimizing apparatus 1 can provide an approximate solution that ensures a better approximation rate than before for an optimization problem on condition that a predetermined assumption is satisfied. In addition, the optimizing apparatus 1 can provide a technique in which the calculation time is not increased even in a case where the remaining amount rᵤ of each node u takes a large value.

### OTHER EMBODIMENTS

In the above embodiment, the example in which the optimization problem (P) is transformed into the minimum convex cost flow problem (FP) on condition that Assumption 1 is satisfied has been described. However, Assumption 1 may be any assumption as long as the optimization problem (P) can be transformed into the minimum convex cost flow problem (FP).

The solution method of the optimization problem described in the present embodiment is a solution method of a general optimization problem. Therefore, the present embodiment is not limited to the above-described problem, and can be applied to various problems that can result in a formulated optimization problem.

In addition, the methods described in the above-described embodiment can be stored in a storage medium such as a magnetic disk (floppy (registered trademark) disk, hard disk, or the like), an optical disk (CD-ROM, DVD, MO, or the like), or a semiconductor memory (ROM, RAM, flash memory, or the like) as programs (software means) that can be executed by a computing machine (computer), or can also be distributed by being transmitted through a communication medium. Note that the programs stored on the medium side also include a setting program for configuring, in the computing machine, software means (not only an execution program but also tables and data structures are included) to be executed by the computing machine. The computing machine that implements the present device reads the program stored in the storage medium, constructs the software means by the setting program as the case may be, and executes the above-described processing by the operation being controlled by the software means. Note that the storage medium described in the present specification is not limited to a storage medium for distribution, and includes a storage medium such as a magnetic disk or a semiconductor memory provided inside a computing machine or in a device connected via a network.

In short, the present invention is not limited to the above embodiment, and various modifications can be made in the implementation stage without departing from the gist thereof. In addition, the embodiment may be implemented in appropriate combination if possible, and in this case, combined effects can be obtained. Further, the above-described embodiment includes inventions at various stages, and various inventions can be extracted by appropriate combinations of a plurality of the disclosed requirements.

### REFERENCE SIGNS LIST

1 Optimizing apparatus
2 Input device
3 Output device
10 Control unit
101 Acquisition unit
102 Formulation unit
103 Optimization unit
1031 Determination unit
1032 Problem transformation unit
1033 Problem solving unit
104 Output control unit
20 Program storage unit
30 Data storage unit
301 Parameter storage unit
40 Communication interface
50 Input/output interface

1. An optimizing apparatus capable of solving an online matching problem capable of controlling each node and an appearance probability, the optimizing apparatus comprising:
circuitry configured to
acquire input data including information regarding the node, a remaining amount given to a fixed node among nodes, the appearance probability given to an appearance node among the nodes, and a reward given to each edge when matching is performed;
perform formulation to a first optimization problem that maximizes a total of rewards obtained based on the input data;
determine whether or not all of the appearance nodes satisfy a predetermined assumption;
perform transformation into a second optimization problem capable of obtaining an approximate solution to a variable that controls a weight of each node and the appearance probability in the first optimization problem and a matching strategy in a case where the predetermined assumption is satisfied;
obtain the approximate solution by solving the second optimization problem; and
output the approximate solution.

2. The optimizing apparatus according to claim 1, wherein the circuitry further configured to
transform the second optimization problem into a third optimization problem in which an objective function becomes a convex function according to Assumption 1, and
obtain the approximate solution by solving the third optimization problem.

3. The optimizing apparatus according to claim 1, wherein the circuitry further configured to
transform the second optimization problem into a third optimization problem in which the objective function becomes a convex function according to Assumption 1,
transform the third optimization problem into a minimum convex cost flow problem based on a point that the third optimization problem has the same structure at each time, and
obtain the approximate solution by solving the minimum convex cost flow problem.

4. The optimizing apparatus according to claim 1, wherein the predetermined assumption is an assumption that pᵥ(x) that is an appearance probability is lim_{x→∞}pᵥ(x)=0, a variable x in which pᵥ(x)=0 is included in a domain, −p′ᵥ(x)/pᵥ(x) is monotonically non-decreasing, and pᵥ(x) is bijective and monotonically decreasing.

5. The optimizing apparatus according to claim 1, wherein the variable and the matching strategy are 1/(1−√(3+k)) approximation rates of the first optimization problem, k=minᵤrᵤ, u is the fixed node, and rᵤ is the remaining amount given to the fixed node.

6. An optimizing method performed by a processor of an optimizing apparatus capable of solving an online matching problem capable of controlling each node and an appearance probability, the optimizing method comprising:
acquiring input data including information regarding the node, a remaining amount given to a fixed node among nodes, the appearance probability given to an appearance node among the nodes, and a reward given to each edge when matching is performed;
performing formulation to a first optimization problem that maximizes a total of rewards based on the input data;
determining whether or not all of the appearance nodes satisfy a predetermined assumption;
performing transformation into a second optimization problem capable of obtaining an approximate solution to a variable that controls a weight of each node and the appearance probability in the first optimization problem and a matching strategy in a case where the predetermined assumption is satisfied;
obtaining the approximate solution by solving the second optimization problem; and
outputting the approximate solution.

7. A non-transitory computer readable storage medium storing a computer program which is executed by a processor of an optimizing apparatus capable of solving an online matching problem capable of controlling each node and an appearance probability to provide the steps of:
acquiring input data including information regarding the node, a remaining amount given to a fixed node among nodes, the appearance probability given to an appearance node among the nodes, and a reward given to each edge when matching is performed;
performing formulation to a first optimization problem that maximizes a total of rewards based on the input data;
determining whether or not all of the appearance nodes satisfy a predetermined assumption;
performing transformation into a second optimization problem capable of obtaining an approximate solution to a variable that controls a weight of each node and the appearance probability in the first optimization problem and a matching strategy in a case where the predetermined assumption is satisfied;
obtaining the approximate solution by solving the second optimization problem; and
outputting the approximate solution.
